(19) United States
(12) Patent Application Publication
(10) Pub. No.: US 2007/0242045 A1
(43) Pub. Date: Oct. 18, 2007

(54) ROLLER FUNCTION SWITCHING METHOD

(75) Inventors: Chih-Feng Chien, Taipei (TW); Tzu-Chiang Shih, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd., Taipei (TW)

(21) Appl. No.: 11/428,791

(22) Filed: Jul. 5, 2006

(30) Foreign Application Priority Data
Apr. 14, 2006 (TW) 95113308

(51) Int. Cl. G09G 5/08

(52) U.S. Cl. 345/163

(57) ABSTRACT

A roller function switching method is used between a mouse device and a computer system operated with a browser program. Firstly, the computer system is operated in a roller function switching mode. Then, the computer system controls the browser program to change a browsing page in response to a directional rolling signal generated by rotating the roller of the mouse device in a first function state. Afterward, the computer system controls the browser program to scroll the browsing page in response to the directional rolling signal generated by rotating the roller of the mouse device in a second function state. The roller function is switched between the first function state and the second function state in response to a function state switching signal generated by the operation of the mouse device.

### FIELD OF THE INVENTION

The present invention relates to a roller function switching method, and more particularly to a roller function switching method used between a mouse device and a computer system operated with a browser program.

### BACKGROUND OF THE INVENTION

Conventionally, the user operation interface of a computer system usually includes a keyboard for inputting operating instructions therevia. After the operating instructions are inputted into the computer system via the keyboard, related operations will be processed in the computer system. Since these operating instructions are written in complicated program languages, the user operation interface for inputting operating instructions becomes hindrance from using the computer system and thus the functions of the computer system fail to be optimized. Nowadays, computers become essential data processing apparatuses in the digitalized and electronic societies. For helping the user well operate the computer system, the hardware and the software associated with the computer system are developed in views of humanization and user-friendliness. For example, when the software is running in the Windows or Linux environment, graphic user interfaces (GUIs) are widely used. The hardware conforming to the graphic user interface usually includes an essential keyboard and optionally a cursor control device. An exemplary cursor control device is a mouse device for executing data processing operations via the graphic user interface, thereby exempting from the complicated procedures of inputting instructions and program languages. By means of the mouse device, the user can click the selected graphic-based function menu under the operation system without difficulties.

In the early stage, the mouse device is designed on the basis of the utility conforming to the graphic user interface under the operation system. Under this circumstance, the mouse device is designed to have the clicking function and other functions useful as the general cursor control device. Nowadays, with increasing demand of using the mouse device as the control device of the graphic user interface under the operation system or the graphic user interface provided by the application software executed under the operation system, the mouse devices having a variety of functions and hardware configurations are designed and the associated technologies are well established in order to meet the users' requirements. For example, the mechanism for sensing the moving direction and displacement of the mouse device is developed from a trackball mechanism to an optical sensing mechanism, so that the cursor is moved in a more precise manner. Furthermore, the method for transmitting signals is advanced from the wired signal transmission technology to the wireless transmission technology. For practicability, a roller button is additionally arranged between the two click buttons. By the roller button of the mouse device, the user may easily perform related operations.

Referring to FIG. 1(a), a schematic outlook view of a three-button mouse device 10 is illustrated. The three-button mouse device 10 includes a first click button 11, a second click button 12 and a roller 13 arranged between the first click button 11 and the second click button 12. By clicking the first click button 11 and the second click button 12 to trigger function keys on the graphic user interface under the operation system or the graphic user interface provided by the application software executed under the operation system, the computer may execute a selected function. In a case that a web page is browsed, the user may either directly click the first click button 11 or the second click button 12 to hyperlink with the selected web page or open the prompt function option menu for selection. If the web page has a length more than one page, the whole content of the web page fail to be simultaneously shown on the display screen. Under this circumstance, by rotating the scroll bar beside the graphic user interface, the web page would be scrolled upwardly or downwardly in order to be browsed. Likewise, according to the rotating degree of the roller 13, the web page is quickly scrolled in the vertical direction, so that the desired content of the web page is promptly browsed.

As known, the frequently used commands in browsing the web pages are related to the previous page/next page functions. The process of operating the three-button mouse device 10 is not convenient because the cursor should be controlled to move to the graphic user interface to trigger the selected function key.

Another mouse having multi-function buttons was developed. Referring to FIG. 1(b), a schematic outlook view of a five-button mouse 20 is illustrated. In addition to a first click button 21, a second click button 22 and a roller 23, the five-button mouse 20 further includes a fourth button 24 and a fifth button 25. For example, according to the Microsoft operation system, the fourth button 24 and the fifth button 25 are triggered to execute the “previous page” function and the “next page” function, respectively. When the user presses down the fourth button 24, the operation system may execute the “previous page” function. Whereas, the “next page” function is executed when the fifth button 25 is pressed down. In other words, the previous page/next page functions are executed without moving the cursor to the graphic user interface for triggering the selected function key.

In comparison with the three-button mouse device 10, the five-button mouse 20 is not cost-effective. In addition, the five-button mouse 20 is not user-friendly on account of installing the specified mouse driver and setting the functions of fourth and fifth buttons in order to execute the previous page/next page functions.

In views of the above-described disadvantages resulted from the prior art, the applicant keeps on carving unflaggingly to develop a roller function switching method according to the present invention through wholehearted experience and research.

### SUMMARY OF THE INVENTION

It is an object of the present invention to provide a roller function switching method for use with a three-button mouse having a roller so as to execute the page-switching function similar to the five-button mouse device.

In accordance with an aspect of the present invention, there is provided a roller function switching method used between a mouse device and a computer system operated with a browser program. Firstly, the computer system is operated in a roller function switching mode. Then, the computer system controls the browser program to change a browsing page in response to a directional rolling signal generated by rotating the roller of the mouse device in a first function state. Afterward, the computer system controls the browser program to scroll the browsing page in response to the directional rolling signal generated by rotating the roller of the mouse device in a second function state. The roller function is switched between the first function state and the second function state in response to a function state switching signal generated by the operation of the mouse device.

In an embodiment, the roller function switching mode is enabled or disabled via a function operation interface provided by a specified application program, which is installed in the computer system and includes a roller function switching capability.

In an embodiment, the computer system in the first function state is switched to the second function state when the roller is pressed down.

In an embodiment, the computer system in the second function state is switched to the first function state when the roller is pressed down.

In an embodiment, the directional rolling signal generated by rotating the roller is a forward rolling signal or a backward rolling signal. In response to the forward rolling signal, the computer system in the first function state controls the browsing program to change the browsing page to a previous page. In response to the backward rolling signal, the computer system in the first function state controls the browsing program to change the browsing page to a next page.

In accordance with another aspect of the present invention, there is provided a third axle function switching method used between a third axle input device and a computer system operated with a browser program. Firstly, the computer system is operated in a third axle function switching mode. Then, the computer system controlling the browser program to change a browsing page in response to a directional rolling signal generated by triggering a third axle function input key in a first function state. Afterward, the computer system controls the browser program to scroll the browsing page in response to the directional rolling signal generated by triggering the third axle function input key in a second function state. The third axle function is switched between the first function state and the second function state in response to a function state switching signal generated by the operation of the third axle input device.

In an embodiment, the third axle function switching mode is enabled or disabled via a function operation interface provided by a specified application program, which is installed in the computer system and includes a third axle function switching capability.

In an embodiment, the directional rolling signal generated by triggering the third axle function input key is a forward rolling signal or a backward rolling signal. In response to the forward rolling signal, the computer system in the first function state controls the browsing program to change the browsing page to a previous page. In response to the backward rolling signal, the computer system in the first function state controls the browsing program to change the browsing page to a next page.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic outlook view of a conventional three-button mouse device;

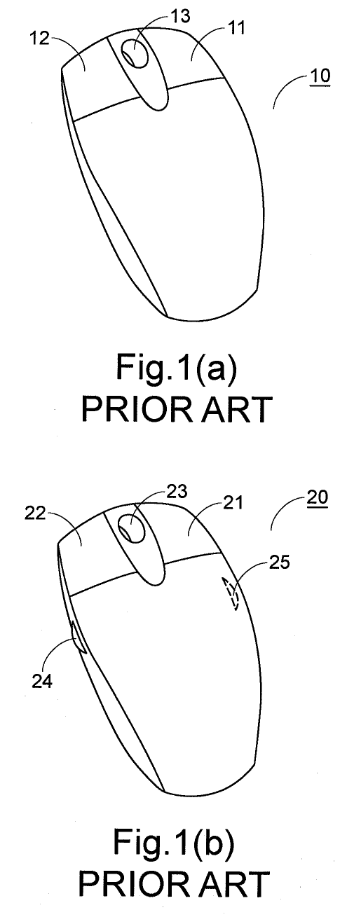

FIG. 1(b) is a schematic outlook view of a conventional five-button mouse;

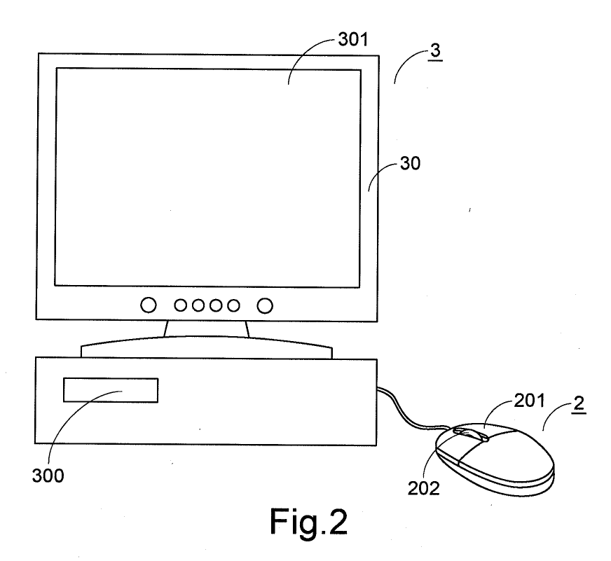

FIG. 2 is a schematic view illustrating a mouse device used with a computer system according to a preferred embodiment of the present invention;

FIG. 3(a), (b) is a flowchart illustrating the steps of a roller function switching method according to the present invention; and

FIG. 4 is a schematic view illustrating another mouse device for controlling third axle movement of the cursor by touching a thin film switch array.

### DETAILED DESCRIPTION OF THE PREFERRED EMBODIMENT

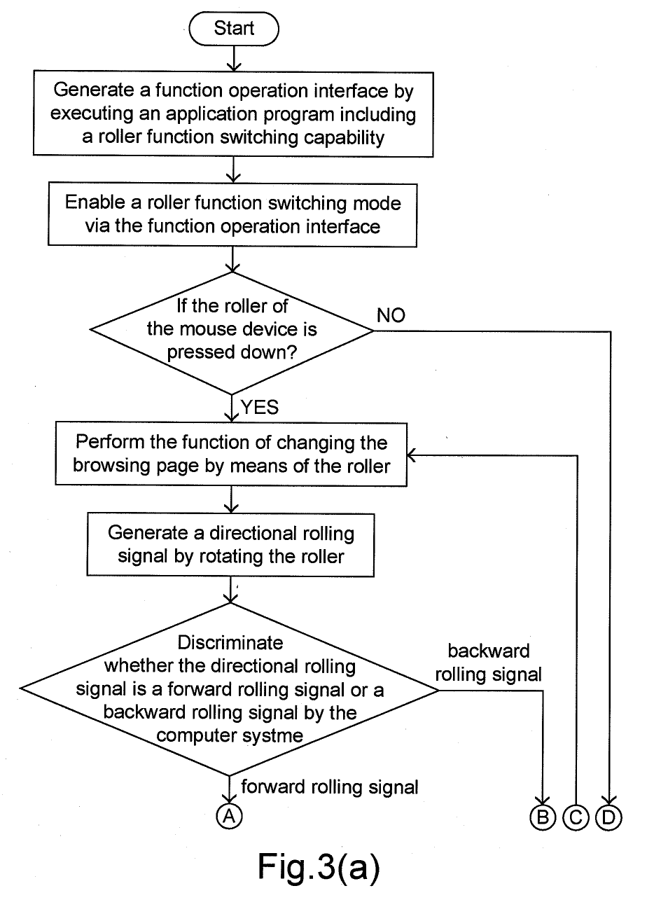

Referring to FIG. 2, a mouse device 2 for use with a computer system according to a preferred embodiment of the present invention is illustrated. The mouse device 2 is communicated with the computer system 3 for controlling the browsing page shown on the display screen 30. The mouse device 2 comprises a click button 201 and a roller 202. When a browser program 300 installed in the computer system 3 is executed, a browsing frame 301 is shown on the display screen 30. Meanwhile, by operating the click button 201 and the roller 202, the user may select a desired item on the function menu of the browsing frame 301 and browse the selected web pages (for example by hyperlink).

Generally, if the web page to be shown on the browsing frame 301 has a length more than one page, the user may rotate the roller 202 to scroll the browsing page on the browsing frame 301. For example, in a case that the roller 202 is rolled forwardly, a forward rolling signal is issued from the roller 202 to the computer system 3 and thus the browsing frame 301 is scrolled up. In contrast, in a case that the roller 202 is rolled backwardly, a backward rolling signal is issued from the roller 202 to computer system 3 and thus the browsing frame 301 is scrolled down.

In accordance with a major feature of the present invention, via the function operation interface provided by a specified application program in the computer system 3, the roller function switching mode is enabled or disabled. Originally, the roller 202 is used for scrolling the web page. Once the computer system 3 enters the roller function switching mode, the browser program 300 is executed to change the browsing page in a first state or scroll the browsing page in a second state by operating the mouse device 2. As such, when the browser program 300 is executed in the first state and the web page is browsed on the browsing frame 301, the roller 202 is triggered to execute the “previous page” function or the “next page” function. The mouse device 2 has a switch element (not shown) under the roller 202. When the computer system 3 enters the roller function switching mode and the roller 202 is depressed to trigger the switch element, a function status switching signal is issued to the computer system 3. In response to the function status switching signal, the computer system 3 operated with the application program having the roller function switching capability will switch the function of scrolling the browsing page to the function of changing the browsing page upon rotation of the roller 202. Under this circumstance, when the roller 202 is rolled forwardly, a forward rolling signal is issued from the roller 202 to the computer system 3 and thus the browsing page on the browsing frame 301 is scrolled up to execute the “previous page” function. In contrast, when the roller 202 is rolled backwardly, a backward rolling signal is issued from the computer system 3 and thus the browsing page on the browsing frame 301 is scrolled down to execute the “next page” function. Moreover, if the roller 202 is depressed again, the computer system is operated from the page-changing state to the page-scrolling state and the browsing page will be scrolled by rotating the roller 202.

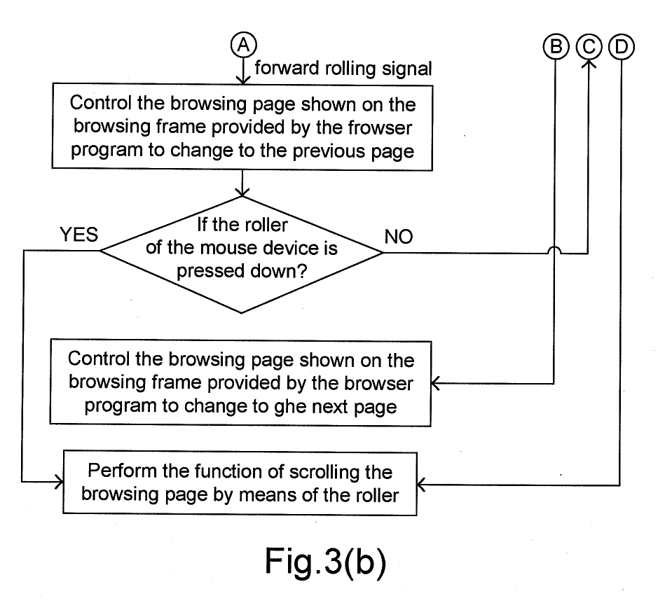

Referring to FIG. 3(a),(b), a flowchart of a roller function switching method according to the present invention is illustrated. Firstly, when an application program including a roller function switching capability is executed in the computer system, a function operation interface is generated. Then, via the function operation interface, a roller function switching mode of the computer system is enabled. If the roller of the mouse device is pressed down; the browser program of the computer system will be executed to perform the function of changing the browsing page in a page-changing state by rotating the roller. Otherwise, the application program of the computer system may perform the function of scrolling the browsing page in a page-scrolling state by rotating the roller. In the page-changing state, a directional rolling signal is generated from the mouse device when the roller is rotated, and the computer system will discriminate whether the directional rolling signal is a forward rolling signal or a backward rolling signal. In a case that the directional rolling signal is the forward rolling signal, the browsing page shown on the browsing frame, which is provided by the browser program, will be controlled by the computer system, thereby changing to the previous page. In another case that the directional rolling signal is the backward rolling signal, the browsing page shown on the browsing frame, which is provided by the browser program, will be controlled by the computer system, thereby changing to the next page. When the mouse device is operated in the page-changing state and pressed down again, the operation status of the mouse device will be switched to the page-scrolling state. By the way, the roller function switching mode will be disabled if the roller function switching setting in the function operation interface is cancelled. When the roller function switching mode is disabled, the mouse device is restored to the original page-scrolling state. Under this circumstance, the operation status of the mouse device maintains the original page-scrolling state even though the roller is pressed down.

From the above description, by executing the application program including a roller function switching capability in the computer system to have the mouse device operated in the roller function switching mode according to the roller function switching method of the present invention, the operation status of the mouse device is switched from the original page-scrolling state to the page-changing state. In the page-changing state, a forward or backward rolling signal is generated from the roller when the roller is rotated. In response to the forward or backward rolling signal, the browser program is controlled to change the browsing page to the previous or next page. On the other hand, if the mouse device should be operated in the page-scrolling state when other specified application programs are executed, the roller function switching mode can be disabled and restored to the original page-scrolling state by the browser program including the roller function switching function. As a consequence, the three-button mouse device will have the roller function switching capability identical to the conventional five-button mouse device without adding extra buttons.

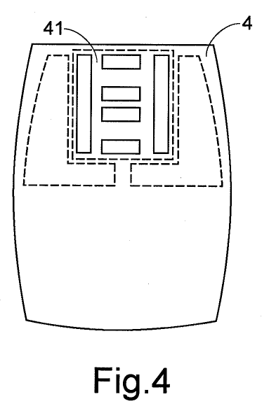

It is noted that, however, those skilled in the art will readily observe that numerous modifications and alterations of the mouse device may be made while retaining the teachings of the invention. For example, the mouse device can be an input device having a third axle to replace the roller. Accordingly, the above disclosure should be limited only by the bounds of the following claims. Referring to FIG. 4, the mouse device 4 has a thin film switch array 41. By touching the thin film switch array 41, the mouse device 4 functions as the roller for controlling the third axle movement.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A roller function switching method used between a mouse device and a computer system operated with a browser program, said mouse device having a roller, said roller function switching method comprising steps of:
allowing said computer system to be operated in a roller function switching mode;
said computer system controlling said browser program to change a browsing page in response to a directional rolling signal generated by rotating said roller of said mouse device in a first function state; and
said computer system controlling said browser program to scroll said browsing page in response to said directional rolling signal generated by rotating said roller of said mouse device in a second function state, wherein the roller function is switched between said first function state and said second function state in response to a function state switching signal generated by the operation of said mouse device.

2. The roller function switching method according to claim 1 wherein said roller function switching mode is enabled or disabled via a function operation interface provided by a specified application program, which is installed in said computer system and includes a roller function switching capability.

3. The roller function switching method according to claim 1 wherein said computer system in said first function state is switched to said second function state when said roller is pressed down.

4. The roller function switching method according to claim 1 wherein said computer system in said second function state is switched to said first function state when said roller is pressed down.

5. The roller function switching method according to claim 1 wherein said function state switching signal is generated when said roller is pressed down.

6. The roller function switching method according to claim 1 wherein said directional rolling signal generated by rotating said roller is a forward rolling signal or a backward rolling signal.

7. The roller function switching method according to claim 6 wherein said computer system in said first function state controls said browsing program to change said browsing page to a previous page in response to said forward rolling signal.

8. The roller function switching method according to claim 6 wherein said computer system in said first function state controls said browsing program to change said browsing page to a next page in response to said backward rolling signal.

9. A third axle function switching method used between a third axle input device and a computer system operated with a browser program, said third axle input device having a third axle function input key, said third axle function switching method comprising steps of:
allowing said computer system to be operated in a third axle function switching mode;
said computer system controlling said browser program to change a browsing page in response to a directional rolling signal generated by triggering said third axle function input key in a first function state; and
said computer system controlling said browser program to scroll said browsing page in response to said directional rolling signal generated by triggering said third axle function input key in a second function state, wherein the third axle function is switched between said first function state and said second function state in response to a function state switching signal generated by the operation of said third axle input device.

10. The third axle function switching method according to claim 9 wherein said third axle function switching mode is enabled or disabled via a function operation interface provided by a specified application program, which is installed in said computer system and includes a third axle function switching capability.

11. The third axle function switching method according to claim 9 wherein said directional rolling signal generated by triggering said third axle function input key is a forward rolling signal or a backward rolling signal.

12. The third axle function switching method according to claim 11 wherein said computer system in said first function state controls said browsing program to change said browsing page to a previous page in response to said forward rolling signal.

13. The third axle function switching method according to claim 11 wherein said computer system in said first function state controls said browsing program to change said browsing page to a next page in response to said backward rolling signal.
